(19) United States
(12) Patent Application Publication
(10) Pub. No.: US 2014/0290342 A1
(43) Pub. Date: Oct. 2, 2014

(54) PRESSURE DETECTING DEVICE AND METHOD

(71) Applicant: David John Drake, Port Orange, FL (US)

(72) Inventor: David John Drake, Port Orange, FL (US)

(21) Appl. No.: 13/851,860

(22) Filed: Mar. 27, 2013

(51) Int. Cl. G01M 3/04

(52) U.S. Cl. CPC G01M 3/04
USPC 73/40.5 R

(57) ABSTRACT

A method and apparatus detects gas or liquid leaks in a building. The device may include a pressure gauge attached to liquid or gas piping in the building. The pressure gauge may detect fluctuations of pressure and may send signals of fluctuations to an indicator. Once the indicator receives the fluctuation, the indicator may be activated.

### BACKGROUND OF THE INVENTION

The present invention relates to leak detection and, more particularly, to a pressure detector that may be used to determine whether there is a liquid or gas leak.

Currently, a gas or liquid leak from pipes may cause serious problems. The leaks may be unnoticed for days, weeks or even months. During that time, the owner may be wasting money and damage may occur. The only way an owner may discover the leak is if the owner physically sees the leak, smells the leak, notices an unusual increase in a particular liquid or gas bill, or discovers damage. At this point, a lot of money may have been wasted and a lot of damage may have occurred.

As can be seen, there is a need for a leak detection device.

### SUMMARY OF THE INVENTION

In one aspect of the present invention, a liquid or gas leakage detection device comprises: a pressure sensor attached to a piping within a building, wherein the pressure sensor senses pressure of the liquid or gas and thereby detects fluctuation of pressure within the piping; and an indicating device electronically connected to the pressure sensor, wherein the pressure sensor sends the indicating device a signal when the pressure detects the fluctuation of pressure, and wherein the indicating device indicates the fluctuation of pressure.

In another aspect of the present invention, a method of detecting liquid or gas leakage comprising: activating a pressure sensor that is attached to a piping in a building; measuring the pressure of the gas or liquid within the piping; activating a solenoid valve that prevents an outside liquid or gas source to the building from entering into the piping; measuring the pressure again; comparing the two measurements of pressure; and activating an indicator when there is a fluctuation of pressure.

These and other features, aspects and advantages of the present invention will become better understood with reference to the following drawings, description and claims.

### BRIEF DESCRIPTION OF THE DRAWINGS

FIG. 1 is a schematic diagram view of the present invention illustrating component relationships; and

FIG. 2 is a schematic flow diagram of a method the present invention upon activation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method and apparatus for detecting leaks in a building. The device may include a pressure gauge attached to liquid or gas piping in the building. The pressure gauge may detect fluctuations of pressure and may send signals of fluctuations to an indicator. Once the indicator receives the fluctuation, the indicator may be activated.

The present invention may include a device that monitors a gas or liquid system in a building. The device may detect a gas or liquid leak at all times, preventing what may be a costly leak and/or damage. However, the present invention is not limited to detecting leaks and may detect any potential discharge of the gas or liquids from the piping.

The present invention may include an indicator mechanism that makes the owner aware of the leak, such as sounds, lights or vibrations. The present invention may be used anywhere where there may be a concern about an undetected leak. For example, the building may include houses, apartment complexes, factories, office building, stores, restaurants and the like. The size of the building does not matter because any amount of solenoid valves and pressure sensors may be installed.

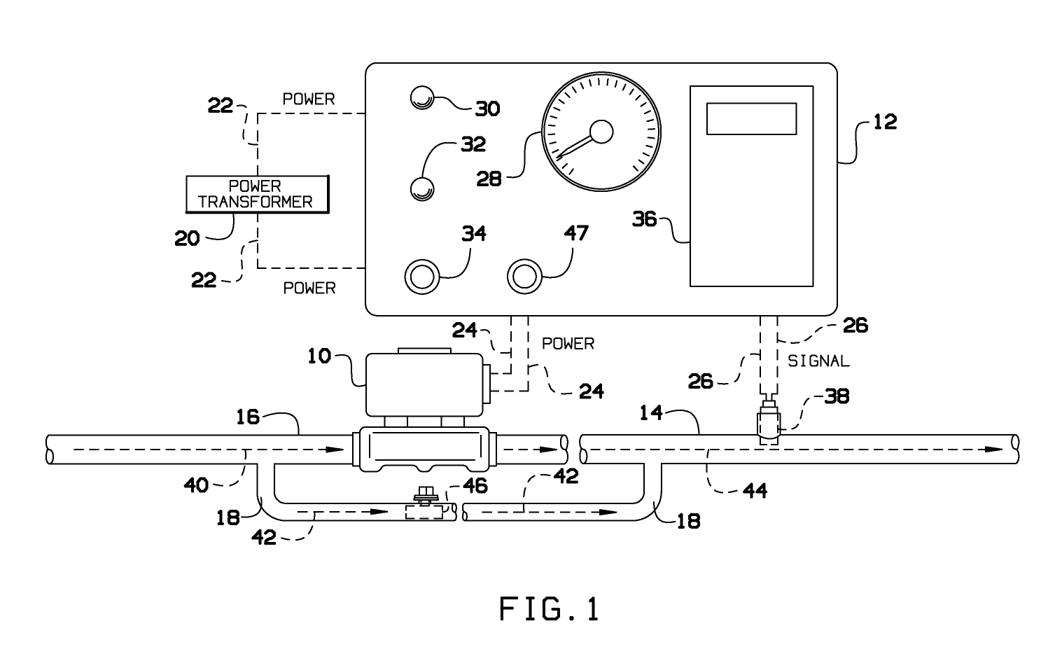

Referring to FIG. 1, the present invention may include a pressure sensor 38. The pressure sensor 38 may determine the pressure of any liquid or gas, such as water. The pressure sensor 38 may be attached to a piping 14 of a building and may measure the PSI of the building gas or liquid flow 44. An indicator may be attached to the pressure sensor 38 electronically. The pressure sensor 38 may send signals to the indicator, including signals based on whether the pressure has fluctuated. If there has been some fluctuation of a predetermined amount of fluctuation, the indicator may indicate such fluctuation by emitting light, sound, or vibrations.

In certain embodiments, the present invention may include a controller 12. The controller 12 may comprise the indicator. Thereby, the pressure sensor 38 may send signals to the controller 12 indicating whether the pressure has fluctuated and the indicator may be activated. In certain embodiments, the indicator may include a green light 32 and a red light 30 displayed on the controller 12. In such embodiments, the green light 32 may indicate a constant pressure and the red light 30 may indicate a fluctuated pressure. The pressure sensor 38 may connect with the controller 12 by the exemplary PSI sensor electrical connections 26. The controller 12 may be powered 20 by a power transformer 22 or batteries. The controller 12 may further include a PSI gauge 28 that displays the pressure sensor 38 readings.

The present invention may further include a programmable relay 36 and a test verification button 34. The test may be done at a time where it is known that no gases or liquids are being used. The timing may be chosen manually or by programmed depending on the system. The programmable relay 36 may be used to preset a day and/or time of day for the system to automatically check the PSI of the liquid or gas flow 44. However, the PSI may be checked manually. The test verification button 34 may be used at any time for testing or to verify the last test results. The test verification button 34 may be activated when the system is on automatic or manual.

The controller 12 may further comprises an on and off button 47. The on and off button 47 may be turned on and left on for all testing manual or automatic. When the pressure sensor 38 is activated, the pressure sensor 38 may take measurements of the liquid or gas 44 pressure and send signals of the measurements back to the controller 12. When the on and off button 47 is turned off, the controller may deactivate the pressure sensor 38.

In certain embodiments, the present invention may further include a solenoid valve 10. The solenoid valve 10 may be a 24 volt solenoid valve. The solenoid valve 10 may be connected and powered by the controller 12 via an exemplary solenoid electrical connection 24. The solenoid valve 10 may be connected between the supply piping 16 and the piping 14 of the building. In certain embodiments, when a test is going to be made the electrical solenoid 10 may be activated and may shut off the liquid or gas supply 40 to the building for a period of time. For example, the solenoid valve 10 is activated for a period of time that is based on the system, enough time is needed for any leak to affect the psi in the piping system that is being tested, this could be as little as 5 seconds. The pressure gauge 38 may gauge the pressure before and after electrical solenoid 10 is turned on. If a minor leak is detected, the leak may be recorded and indicated. If the pressure is significantly lower, which may indicate a major leak or broken pipe, the liquid or gas supply 40 may remain off to prevent further damage.

In certain embodiments, the present invention may further include a bypass liquid or gas flow 42 through a bypass piping 18. The bypass liquid or gas flow 42 may flow from the main liquid or gas source piping 16 to the building liquid or gas piping 14 and thereby bypassing the solenoid valve 10. The bypass piping 18 may include a ball valve 46.

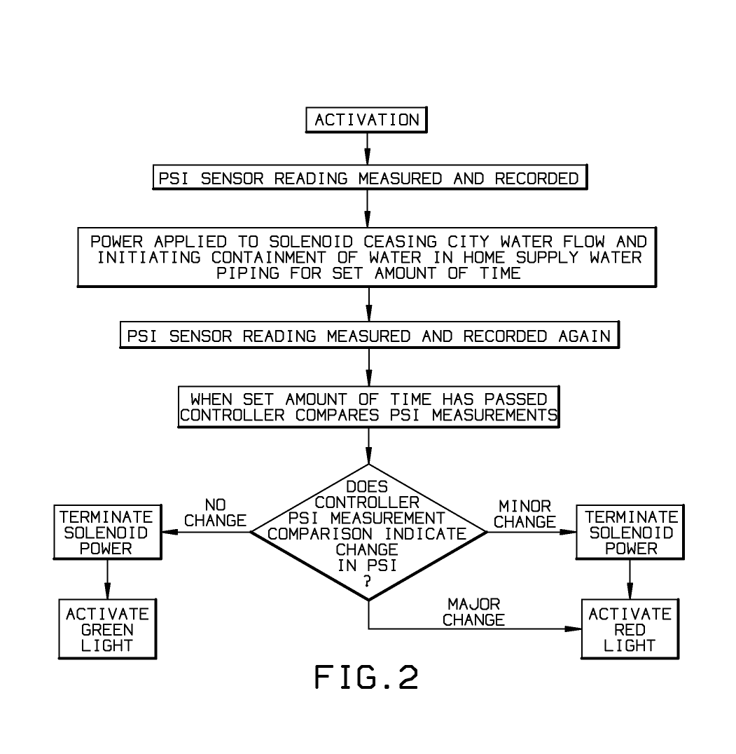

FIG. 2 provides an exemplary flow chart of a method of the present invention involving water. The PSI sensor of the present invention may first be activated. The PSI sensor may measure and record the PSI of the water flow in the building's water pipes. The solenoid valve may be activated to cease the water flow coming into the building and may initiate containment of water in the home supply for a set amount of time. The PSI sensor may measure and record the PSI of the water again. The controller may then compare the psi measurements. If a change of PSI has not been indicated, the solenoid valve may be turned off and the flow of water may resume. The green light may activate on the controller. If there is a minor change of PSI, the he solenoid valve may be turned off and the flow of water may resume. In such embodiments, the red light may activate on the controller. If there is a major change of PSI, the solenoid valve may continue to block the incoming water and the red light may be activated.

The following may include a method of making the device with a water piping system. The water solenoid valve may be installed to the main water supply to the building. The water pressure indicator may be installed anywhere passed the solenoid valve in the buildings water system. The control panel may include a programmable relay; this can be by itself or in a display panel. A 120/24 volt transformer may be the electrical supply for the system and may be wired to the valve, pressure indicator, controller and the display panel. The manual controller that is in the display, when activated, bypasses the auto feature and may be tested at any time. The programmable relay is programmed for the amount of time that is chosen and the time or times of day chosen by the user or when the user would like to do the testing. The relay may be programmed to display any changes in pressure, turns the lights on or off, and is able to keep water turned off until repairs are made.

It should be understood, of course, that the foregoing relates to exemplary embodiments of the invention and that modifications may be made without departing from the spirit and scope of the invention as set forth in the following claims.

What is claimed is:

1. A piping pressure detection device comprising:
a pressure sensor attached to a piping within a building, wherein the pressure sensor senses gas or liquid pressure and thereby detects fluctuation of pressure in the piping; and
an indicating device electronically connected to the pressure sensor, wherein the pressure sensor sends the indicating device a signal when the pressure detects the fluctuation of pressure, and wherein the indicating device indicates the fluctuation of pressure.

2. The piping pressure detection device of claim 1, wherein the gas or liquid is within the piping.

3. The piping pressure detection device of claim 2, wherein the gas or liquid is water.

4. The piping pressure detection device of claim 1, further comprising a controller comprising the indicating device.

5. The piping pressure detection device of claim 4, wherein the indicating device comprises a green light indicating that the pressure has not fluctuated and a red light indicating the pressure has fluctuated.

6. The piping pressure detection device of claim 4, wherein the controller comprises a PSI gauge that displays the PSI detected by the pressure sensor.

7. The piping pressure detection device of claim 4, wherein the controller comprises a test verification button.

8. The piping pressure detection device of claim 4, wherein the controller comprises an on and off button, and wherein the on and off button activates and deactivates the pressure sensor. No leak can be detected with the system off.

9. The piping pressure detection device of claim 4, wherein the controller comprises a programmable relay.

10. The piping pressure detection device of claim 8, further comprising a solenoid valve connected to a main gas or liquid source for the building, wherein the solenoid valve is activated to block the main gas or liquid source from the building for a period of time for measurement when the pressure sensor is activated.

11. The piping pressure detection device of claim 10, wherein the period of time that is needed to detect a leak may vary from system to systems.

12. The piping pressure detection device of claim 10, wherein the solenoid valve remains activated to block the main gas or liquid source when a preset amount of time has expired, any pressure fluctuation is detected by the pressure sensor.

13. The piping pressure detection device of claim 10, further comprising a bypass gas or liquid flow that flows from the main gas or liquid source for the building to the building water pipes and bypassing the solenoid valve.

14. The piping pressure detection device of claim 13, wherein the bypass gas or liquid flow comprises a ball valve.

15. A method of detecting pressure within a piping system comprising:
activating a pressure sensor that is connected to a piping in a building;
measuring a pressure of the gas or liquid flowing within the piping;
activating a solenoid valve that prevents an outside gas or liquid source to the building from entering into the piping;
measuring the pressure again;
comparing the two measurements of pressure; and
activating an indicator when there is a fluctuation of pressure.
